(19) United States
(12) Patent Application Publication
(10) Pub. No.: US 2026/0216878 A1
(43) Pub. Date: Jul. 30, 2026

(54) ROBOT CONTROL SYSTEM, ROBOT CONTROL METHOD, AND PROGRAM

(71) Applicant: Panasonic Intellectual Property Management Co., Ltd., Osaka (JP)

(72) Inventor: MOTOTAKA YOSHIOKA, Osaka (JP)

(21) Appl. No.: 19/141,756

(22) PCT Filed: Oct. 24, 2023
(86) PCT No.: PCT/JP2023/038405

§ 371 Date: Jun. 20, 2025

(30) Foreign Application Priority Data
Mar. 10, 2023 (JP) 2023-037910

(51) Int. Cl. B25J 9/16; B25J 13/08

(52) U.S. Cl. CPC B25J 9/1687; B25J 9/1633; B25J 13/085

(57) ABSTRACT

A robot control system is configured to control a robot, and includes a first operation controller configured to cause the robot to perform a first operation for a task with a contact between a first object and a second object, a force information acquisition unit configured to obtain first force information indicating force generated when the first operation is performed, a first operation completion determination unit configured to determine completion of the first operation, a second operation controller configured to, after the completion of the first operation, cause the robot to perform a second operation based on the first force information for a task that verifies completion of the task with the contact, and a second operation completion determination unit configured to determine completion of the second operation.

### TECHNICAL FIELD

The present disclosure relates to a robot control system configured to control a robot.

### BACKGROUND ART

PTL 1 discloses a technique for performing an operation that includes gripping a connector and inserting the connector into an insertion hole.

### CITATION LIST

### Patent Literature

PTL 1: Japanese Patent Laid-Open Publication No. 2020-138293

### SUMMARY OF INVENTION

However, with the technique disclosed in PTL 1, although a task with a contact, such as inserting the connector into the insertion hole, may appear to succeed, the connection may be insufficient, allowing the connector to be removed due to vibration or impact. For example, if a wire cable connector in a vehicle is insufficiently connected, the wire cable connector may be removed due to vibrations during running.

A robot control system according to the present disclosure is configured to control a robot, and includes a first operation controller configured to cause the robot to perform a first operation for a task with a contact between a first object and a second object, a force information acquisition unit configured to obtain first force information indicating force generated when the first operation is performed, a first operation completion determination unit configured to determine completion of the first operation, a second operation controller configured to, after the completion of the first operation, cause the robot to perform a second operation based on the first force information for a verification task that verifies completion of the task with the contact, and a second operation completion determination unit configure to determine completion of the second operation.

A method of controlling a robot according to the present disclosure is executable by a robot control system that controls the robot and includes: causing the robot to perform a first operation for a task with a contact between a first object and a second object; obtaining first force information indicating force generated when the first operation is performed; determining completion of the first operation; after the completion of the first operation, causing the robot to perform a second operation based on the first force information for a verification task that verifies completion of the task with the contact; and determining completion of the second operation.

A program according to the present disclosure is a program that causes a computer to execute the above-described method.

These general or specific aspects may be implemented as a system, a method, an integrated circuit, a computer program, or a computer-readable recording medium such as a CD-ROM or may be implemented as any combination of a system, a method, an integrated circuit, a computer program, and a recording medium.

The robot control system or the like according to the aspect of the present disclosure enables determination of whether or not the task with contact performed by the robot has succeeded.

### BRIEF DESCRIPTION OF THE DRAWINGS

FIG. 1 is a block diagram of a robot control system according to an exemplary embodiment.

FIG. 2 is a perspective view of a robot performing a task according to the embodiment.

FIG. 3 illustrates a gravitational force acting on a first object.

FIG. 4 illustrates a first operation and first force information in the robot control system according to the embodiment.

FIG. 5 illustrates a second operation and second force information in the robot control system according to the embodiment.

FIG. 6A illustrates the robot control system according to the embodiment displaying the first force information and the second force information.

FIG. 6B illustrates the robot control system according to the embodiment displaying the first force information and the second force information.

FIG. 7 is a flowchart illustrating a method of controlling a robot control according to the embodiment.

### DESCRIPTION OF EMBODIMENTS

Exemplary embodiments will be described below with reference to drawings.

[symbol] that the embodiments described below represent general or specific examples. Numerical values, shapes, materials, constituent elements, arrangements and connections of the constituent elements, steps, order of the steps, and others in the following embodiments are examples and are not intended to limit the present disclosure.

### Exemplary Embodiment

A robot control system according to an exemplary embodiment will be described below.

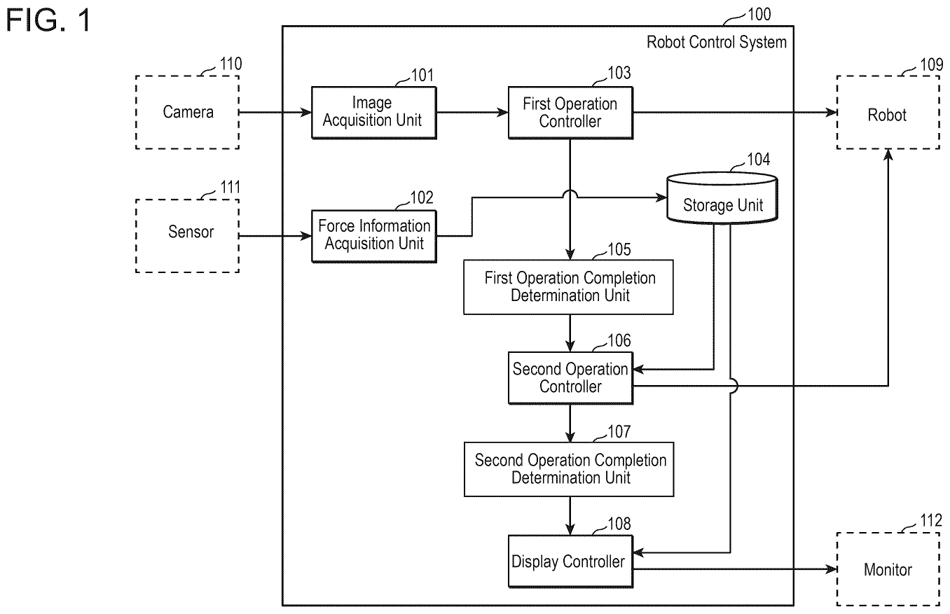

FIG. 1 is a block diagram of robot control system 100 according to the embodiment. In addition to robot control system 100, FIG. 1 illustrates robot 109, camera 110, sensor 111, and monitor 112. Robot control system 100 may include robot 109, camera 110, sensor 111, or monitor 112.

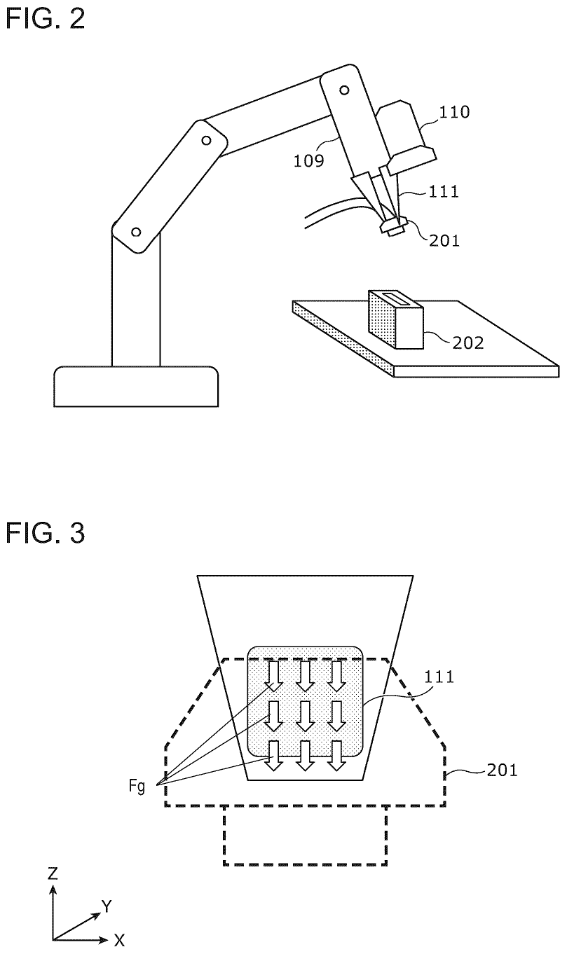

FIG. 2 is an external perspective view of an example of robot 109 performing a task.

As illustrated in FIG. 2, robot 109 may be a manipulator configure to perform a predetermined task while gripping object 201. The predetermined task is a task with a contact between object 201 and object 202. Object 201 is a first object. Object 202 is a second object. For example, objects 201 and 202 are connectors. The task with the contact between objects 201 and 202 is a connector insertion task in which object 201 is inserted into object 202. Object 201 may be a screw while object 202 may be an object having a threaded hole provided therein. In that case, the task with the contact between objects 201 and 202 is a screw fastening task. Object 201 may be a key while object 202 may be an object having a keyhole provided therein. In this case, the task with the contact between objects 201 and 202 is a task turning the key.

Camera 110 is configured to capture images of a space where robot 109 performs the task. For example, the images captured by camera 110 include objects 201 and 202. Camera 110 may be installed to robot 109. Camera 110 may be installed onto a ceiling or a wall in the space where robot 109 performs the task.

Sensor 111 is configured to measure force generated when robot 109 performs the predetermined task while gripping object 201. Examples of sensor 111 include a stress sensor. For example, sensor 111 is provided at a part of robot 109 (specifically, at a leading end of a robot arm of robot 109) where object 201 is gripped. For example, sensor 111 is capable of measuring force in an x-direction (a horizontal direction), force in a y-direction (a horizontal direction perpendicular to the x-direction in a horizontal plane), and force in a z-direction (a vertical direction).

Monitor 112 displays information indicating the force measured by sensor 111 which will be detailed later. For example, monitor 112 may be provided in the space where robot 109 performs the task or in a facility that manages robot 109.

Robot control system 100 is configured to control robot 109 so as to cause robot 109 to perform the predetermined task.

Robot control system 100 includes image acquisition unit 101, force information acquisition unit 102, first operation controller 103, storage unit 104, first operation completion determination unit 105, second operation controller 106, second operation completion determination unit 107, and display controller 108. Robot control system 100 is a computer that includes a processor (microprocessor) and a memory. The memory includes a read-only memory (ROM) and a random-access memory (RAM), and is configured to store programs to be executed by the processor. Image acquisition unit 101, force information acquisition unit 102, first operation controller 103, first operation completion determination unit 105, second operation controller 106, second operation completion determination unit 107, and display controller 108 are implemented by the processor that executes the programs stored in the memory. Storage unit 104 is implemented by the memory. The memory storing the programs and storage unit 104 may be the same memory or may be different memories.

For example, robot control system 100 may be a computer (device) in a single housing or a system composed of plural computers. Alternatively, robot control system 100 may be a server. The constituent elements of robot control system 100 may be disposed in a single server or distributed among plural servers.

Image acquisition unit 101 obtains, from camera 110, image information indicating an image (moving image) including objects 201 and 202.

First operation controller 103 causes robot 109 to perform a first operation for the task (e.g., the above-described connector insertion task, the screw fastening task, or the key turning task) with the contact between objects 201 and 202. First operation controller 103 causes robot 109 to perform the first operation by notifying robot 109 of a control signal (such as an operation plan or an amount of torque) for controlling a drive unit, such as a motor, included in robot 109.

For example, first operation controller 103 causes robot 109 to perform the first operation based on the image information obtained by image acquisition unit 101. For example, first operation controller 103 determines, using the image including objects 201 and 202, three-dimensional coordinates of a destination for object 201 which is to be inserted into object 202, and moves object 201 to the position with the determined three-dimensional coordinates. For example, first operation controller 103 determines a destination for object 201 based on an image at a certain timing, moves object 201 to the destination, and repeats a process that includes determining a next destination for object 201 based on an image at a timing after the movement of object 201 and moving object 201 to the next destination. First operation controller 103 thus causes robot 109 to perform the task, such as inserting object 201 into object 202.

Force information acquisition unit 102 is configured to obtain first force information indicating force generated when the first operation is performed. This force refers to any force generated on object 201 or 202. When objects 201 and 202 contact each other, the force may refer to pressure or frictional force that is generated on object 201 or 202 due to the contact between objects 201 and 202. When objects 201 and 202 do not contact each other, the force may refer to gravitational force that acts on object 201. For example, force information acquisition unit 102 obtains the force generated on object 201 through sensor 111. The first force information is stored in storage unit 104 every time the first force information is obtained, storage unit 104 thus stores the time-series first force information. For example, the first force information includes information indicating forces in the x-direction, y-direction, and z-direction.

First operation completion determination unit 105 is configured to determine completion of the first operation. For example, first operation completion determination unit 105 determines the completion of the first operation based on the image information. For instance, first operation completion determination unit 105 is configured to determine, based on a state of objects 201 and 202 in the image, whether the task (such as the connector insertion task, the screw fastening task, or the key turning task) with the contact between objects 201 and 202 is completed. However, even when the first operation is determined to be complete, the above task may have failed. For example, although the connector insertion task may appear to have succeeded in the image, connection may, in fact, be insufficient.

After the completion of the first operation, second operation controller 106 causes robot 109 to perform a second operation based on the first force information for a verification task that verifies completion of the task with the contact. The second operation will be detailed later. For example, force information acquisition unit 102 obtains second force information indicating force generated when the second operation is performed. When objects 201 and 202 contact each other, this force may refer to the pressure or the frictional force that is caused by the contact. When objects 201 and 202 do not contact each other, the force may refer to the gravitational force that acts on object 201. For example, force information acquisition unit 102 obtains the force generated on object 201 through sensor 111. The second force information is stored in storage unit 104 every time the second force information is obtained, and storage unit 104 thus stores the time-series second force information. For example, the second force information includes information indicating forces in the x-direction, y-direction, and z-direction.

Second operation completion determination unit 107 is configured to determine completion of the second operation. For example, second operation completion determination unit 107 determines the completion of the second operation based on the image information. Second operation completion determination unit 107 will be detailed after the detailed description of the second operation. Second operation completion determination unit 107 may output a determination result regarding the completion of the second operation (for example, a determination result indicating whether the second operation has been properly completed or not).

Display controller 108 is configured to display the first force information and the second force information. This configuration allows a user to check the first force information and the second force information. Display controller 108 will be detailed later.

The gravitational force that acts on object 201 will be described below with reference to FIG. 3.

FIG. 3 illustrates the gravitational force acting on object 201. FIG. 3 illustrates object 201 gripped by robot 109.

As illustrated in FIG. 3, when object 201 is gripped by robot 109 and does not contact any object other than robot 109, sensor 111 which is provided at the part of robot 109 where object 201 is gripped measures the force corresponding to gravitational force Fg acting on object 201. For example, assuming that the positive z-axis direction illustrated in FIG. 3 is vertically upward, sensor 111 measures a negative force when object 201 gripped by robot 109 does not contact any object other than robot 109.

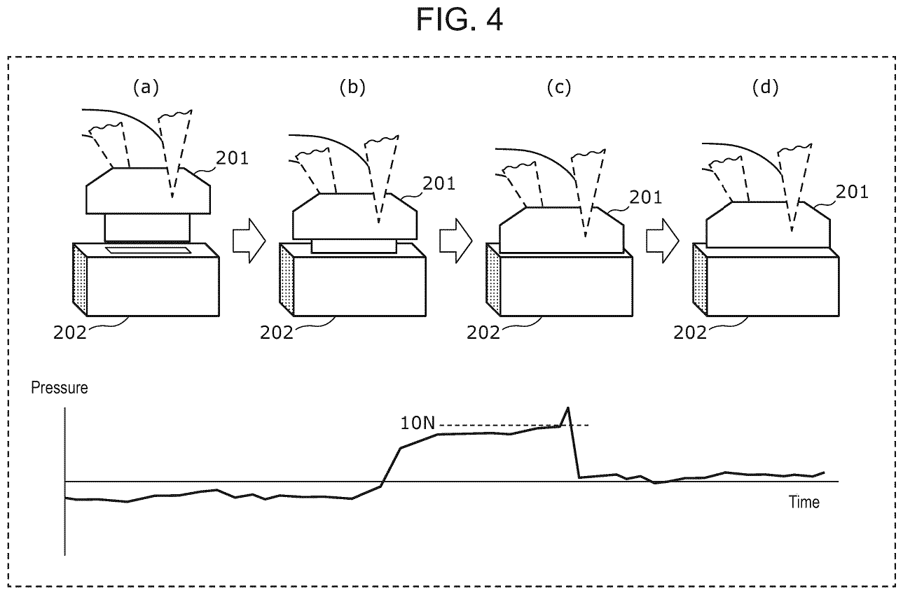

The first operation and the first force information will be detailed below with reference to FIG. 4.

FIG. 4 illustrates the first operation and the first force information. FIG. 4 illustrates, on its top side, processes of the connector insertion task in which object 201 is inserted into object 202 and which serves as an example of the task with the contact between objects 201 and 202. FIG. 4 illustrates, on its bottom side, the first force information (e.g., a time variation of stress) that indicates the force generated when the first operation (connector insertion task) is performed and which is obtained by force information acquisition unit 102. The description below is for a case where the connector is inserted in the z-direction. In this case, the z-direction force changes significantly while the z-direction and y-direction forces do not change significantly. Therefore, only the z-direction force is illustrated in FIG. 4, and the x-direction and y-direction forces are not illustrated.

FIG. 4(a) illustrates a state where object 201 is gripped by robot 109 and does not contact any object other than robot 109, and meaning that object 201 does not contact object 202. In this state, the first force information indicates the force corresponding to the gravitational force acting on object 201.

FIG. 4(b) illustrates a state where object 201 contacts object 202 and is inserted into object 202. In this state, after object 201 contacts object 202, the first force information initially increases to a force required for the insertion of object 201 into object 202 and then indicates that the force remains nearly constant while object 201 is inserted into object 202.

FIG. 4(c) illustrates a state where no further insertion of object 201 into object 202 is possible. In this state, the first force information exhibits a spike (refer to a circled mark shown on the bottom side of FIG. 4(c)). Then, the first operation is completed, and the first force information decreases.

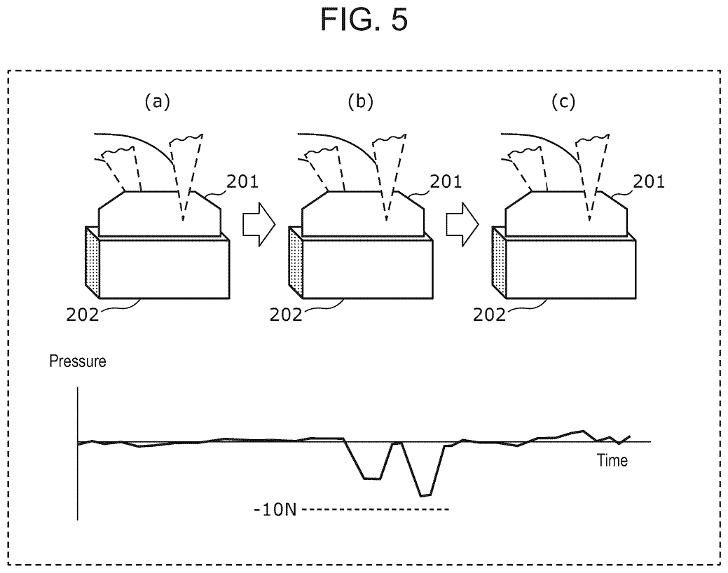

As described above, first operation completion determination unit 105 determines the completion of the first operation based on, for example, the image information. In other words, as illustrated on the top side of FIG. 4(c), the first operation is determined to be complete when object 201 is visually determined to have been inserted into object 202. First operation completion determination unit 105 may determine the completion of the first operation based on audio information. For example, first operation completion determination unit 105 may determine that the first operation is complete when a connector engagement sound is obtained by a microphone. First operation completion determination unit 105 may determine the completion of the first operation based on the first force information. For example, first operation completion determination unit 105 may determine that the first operation is complete when a change (differential) in the force indicated by the first force information is equal to or greater than a predetermined threshold (for example, at a timing corresponding to the circled mark shown on the bottom side of FIG. 4(c)). However, even when the first operation is determined to be complete based on the audio information or the first force information, the task with the contact between objects 201 and 202 may have failed. For this reason, a verification task, which will be described later with reference to FIG. 5, is performed.

FIG. 4(d) refers to a state where object 201 is supported by object 202 with no force applied to object 201 in the z-direction by robot 109. In this state, the first force information is nearly zero. Since object 201 is supported by object 202, the first force information does not include the force corresponding to the gravitational force that acts on object 201.

The second operation and the second force information will be detailed below with reference to FIG. 5.

FIG. 5 illustrates the second operation and the second force information. FIG. 5 illustrates, on its top side, a flow of the verification task that verifies the completion of the connector insertion task, which refers to inserting object 201 into object 202, and which serves as an example of the verification task that verifies the completion of the task with the contact between objects 201 and 202. FIG. 5 illustrates, on its bottom side, the second force information (e.g., a time variation of the stress) that indicates the force generated when the second operation (verification task) is performed and which is obtained by force information acquisition unit 102. Here again, only the z-direction force is illustrated, and the x-direction and y-direction forces are not illustrated.

FIG. 5(a) illustrates a state where, as in FIG. 4(d), object 201 is supported by object 202, and the second operation is not performed. In this state, the second force information is nearly zero.

In FIG. 5(b), second operation controller 106 causes robot 109 to perform the second operation with a force weaker than the force indicated by the first force information. Specifically, second operation controller 106 causes robot 109 to perform the second operation with the force with an absolute value smaller than an absolute value of the force indicated by the first force information. For example, the force indicated by the first force information may be a force generated when the completion of the first operation has been determined. When the force indicated by the first force information is, for example, 10 N, as shown on the bottom side of FIG. 4(c), second operation controller 106 causes robot 109 to perform the second operation with the force weaker than 10 N. For example, the direction of the force that acts on objects 201 and 202 in the second operation is opposite to the direction of the force that acts on objects 201 and 202 in the first operation. Therefore, the force with which robot 109 performs the second operation by second operation controller 106 ranges, for example, from 0 N to −10 N, as shown on the bottom side of FIG. 5(b). Since the second operation is performed, as described, with the force weaker than the force generated in the first operation, the task with the contact between objects 201 and 202 is prevented from ending in failure due to the verification task despite having succeeded. For example, the connector is prevented from being pulled out in the verification task despite having been successfully inserted.

Second operation controller 106 may cause robot 109 to perform the second operation at least twice consecutively and may cause robot 109 to subsequently perform the second operation, for example, with a force weaker than a force with which the second operation is precedingly performed. FIG. 5(b) illustrates, on the bottom side, a case where the second operation is performed twice consecutively with the force used in the second instance of the second operation being weaker than that used in the first instance of the second operation. Performing the second operation at least twice can make the verification task more reliable. Furthermore, since the force with which the second operation is performed is gradually reduced, the task with the contact between objects 201 and 202 is further prevented from resulting in failure due to the verification task despite having succeeded.

FIG. 5(c) illustrates a state where object 201 is supported by object 202 with no force applied to object 201 by robot 109. In this state, the second force information is nearly zero.

As described above, second operation completion determination unit 107 determines the completion of the second operation based on, for example, the image information. In other words, as illustrated on the top side of FIG. 5(c), the second operation is determined to have been properly completed when object 201 is visually determined to have remained inserted into object 202. On the other hand, when object 201 is visually determined to have come loose from object 202, the second operation is determined not to have been properly completed.

Second operation completion determination unit 107 may determine the completion of the second operation based on the second force information. For example, when the second force information is determined to be nearly zero, as shown on the bottom side of FIG. 5(c), it is determined that object 201 is supported by object 202 without having come loose from object 202, allowing a determination that the second operation has been properly completed. On the other hand, when the second force information indicates the force corresponding to the gravitational force that acts on object 201, it is determined that object 201 has come loose from object 202, allowing a determination that the second operation has not been properly completed.

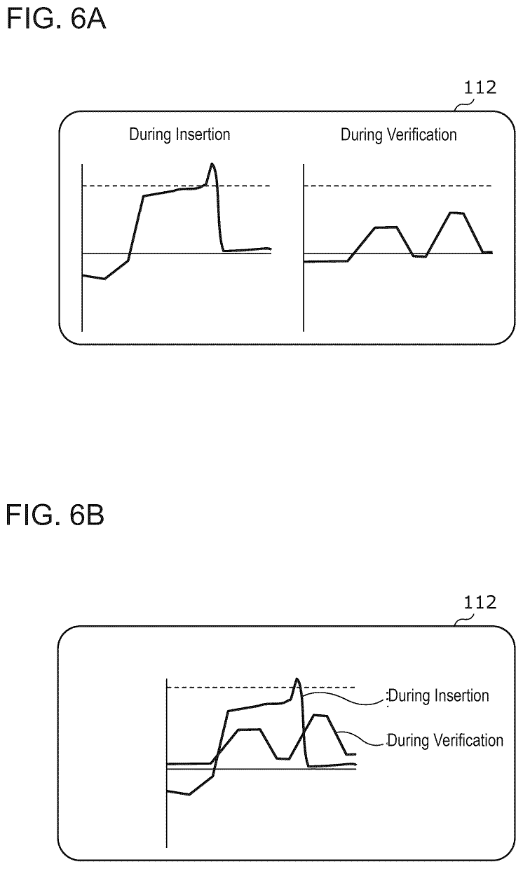

Display controller 108 will be detailed below with reference to FIGS. 6A and 6B.

FIGS. 6A and 6B illustrate examples of the display of the first force information and the second force information.

For example, as illustrated in FIG. 6A, display controller 108 may display the first force information and the second force information side by side on monitor 112. In FIG. 6A, a graph labeled “DURING INSERTION” shows the first force information obtained when the first operation is performed, while a graph labeled “DURING VERIFICATION” shows the second force information obtained when the second operation is performed. This display allows the user to check the first force information and the second force information while comparing the first force information and the second force information and visually determine whether or not the task with the contact performed by robot 109 has succeeded.

For example, as illustrated in FIG. 6B, display controller 108 may display the first force information and the second force information while allowing the first force information and the second force information to overlap each other. In FIG. 6B, a graph labeled “DURING INSERTION” shows the first force information obtained when the first operation is performed, while a graph labeled “DURING VERIFICATION” shows the second force information obtained when the second operation is performed. This display allows the user to check the first force information and the second force information while comparing the first force information and the second force information and visually determine whether or not the task with the contact performed by robot 109 has succeeded.

When the direction of the force from the second operation is opposite to the direction of the force from the first operation, displaying the first force information and the second force information as they are may cause the user to hardly compare the first force information and the second force information. To address this, display controller 108 may display the first force information and the second force information with a sign of one of the first force information and the second force information reversed. For example, the sign of the second force information is reversed in FIGS. 6A and 6B. Reversing the sign of the one of the first force information and the second force information allows the user to easily compare the first force information and the second force information.

For example, in order to determine whether the task with the contact, such as inserting a connector, fastening a screw, or turning a key, has been successful or not, a person may perform, as described above, the verification task, such as lightly pulling the inserted connector, gently turning the screw in a reverse direction, or slightly turning the key backward. Since the person remembers a feeling of force applied when performing the above task with the contact, the person can perform the verification task. Accordingly, according to the present disclosure, the second operation for the verification task is performed based on the force generated when robot 109 performs the first operation for the task with the contact. In other words, the second operation is performed while the force generated during the first operation is took into account; therefore, the verification task similar to what the person would do, such as lightly pulling the inserted connector, gently turning the screw in the reverse direction, or slightly turning the key backward, can be performed. Consequently, it is determined whether the task with the contact performed by robot 109 has succeeded or not.

### Other Embodiments

The embodiment described above exemplifies the technology according to the present disclosure. However, the technology according to the present disclosure is not limited to this embodiment and is also applicable to embodiments that include, among others, appropriate modifications, substitutions, additions, or omissions. For example, variations below are included among the embodiments of the present disclosure.

For example, in the example described in the above embodiment, second operation controller 106 causes robot 109 to perform the second operation with the force weaker than the force indicated by the first force information; however, this is not limited. For example, second operation controller 106 may cause robot 109 to perform the second operation with a force equal to or greater than the force indicated by the first force information. In the connector insertion task, for instance, the force required to pull out the connector may be greater than the force required to insert the connector. In that case, second operation controller 106 does not necessarily cause robot 109 to perform the second operation with a force weaker than the force indicated by the first force information.

For example, in the case described in the above embodiment, second operation controller 106 causes robot 109 to perform the second operation at least twice consecutively; however, second operation controller 106 may cause robot 109 to perform the second operation only once.

For example, in the example described in the above embodiment, robot control system 100 includes image acquisition unit 101; however, robot control system 100 does not necessarily include image acquisition unit 101. For example, when the task to be performed by robot 109 is a task simple enough to reciprocate along a predetermined path, first operation controller 103 may cause the first operation to be performed without using any images including the space where the task is performed.

For example, in the example described in the above embodiment, robot control system 100 includes display controller 108; however, robot control system 100 does not necessarily include display controller 108.

The present disclosure can be implemented not only as robot control system 100 but also, for example, as a robot control method that includes steps (tasks) to be performed by the constituent elements of robot control system 100.

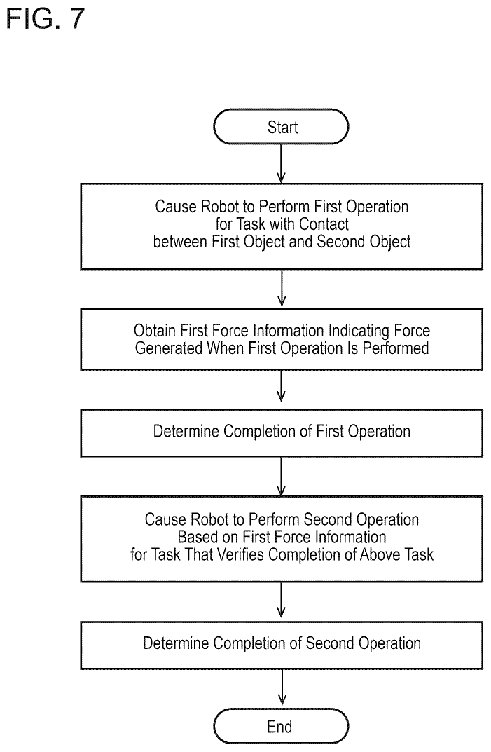

FIG. 7 is a flowchart illustrating an exemplary robot control method according to the embodiment.

The robot control method is a robot control method to be executed by a robot control system that controls a robot. As illustrated in FIG. 7, the robot control method includes a first operation control step (step S11) of causing the robot to perform the first operation for the task with the contact between the first object and the second object; a force information acquisition step (step S12) of obtaining the first force information indicating the force generated when the first operation is performed; a first operation completion determination step (step S13) of determining the completion of the first operation; a second operation control step (step S14) of, after the completion of the first operation, causing the robot to perform the first force information-based second operation for the verification task that verifies the completion of the task with the contact; and a second operation completion determination step (step S15) of determining the completion of the second operation.

For example, the present disclosure can be implemented as a program that causes a computer (processor) to execute the steps included in the robot control method. Furthermore, the present disclosure can be implemented as a nontransitory computer-readable recording medium, such as a CD-ROM, on which the program is recorded.

When, for example, the present disclosure is implemented as a program (software), the program is executed using hardware resources, such as the computer's CPU, memory, and input/output circuitry. In this way, the steps are carried out. In other words, the CPU obtains data from the memory, the input/output circuitry, or the like, performs computations, and outputs computation results to the memory, the input/output circuitry, or the like, thereby executing the steps.

In the above embodiment, the constituent elements included in robot control system 100 may be implemented by dedicated hardware or by executing software programs suitable for the constituent elements. The constituent elements may be implemented when a program execution unit, such as a CPU or a processor, reads and executes the software programs recorded on a hard disk, semiconductor memory, or another recording medium.

Some or all of the functions of robot control system 100 according to the above embodiment are typically implemented by an LSI, which is an integrated circuit. Some or all of the functions may be individually implemented on single chips or integrated into a single chip. Circuit integration is not limited to the LSI and may be implemented using dedicated circuitry or a general-purpose processor. A field-programmable gate array (FPGA) that is programmable after LSI manufacturing or a reconfigurable processor that allows for reconfiguration of connections and settings of circuit cells inside an LSI may be used.

Furthermore, if a circuit integration technology that replaces LSIs emerges due to advances in semiconductor technology or other derivative technologies, that technology may, of course, be used for circuit integration of the constituent elements included in robot control system 100.

The present disclosure also encompasses embodiments arrived at by various modifications to the embodiments that are conceived by those skilled in the art and embodiments realized by combining constituent elements and functions of choice from the embodiments without departing from the spirit of the present disclosure.

### Note

The following technologies have been disclosed based on the description of the above embodiments.

Technology 1: A robot control system configured to control a robot, the robot control system including: a first operation controller configured to cause the robot to perform a first operation for a task with a contact between a first object and a second object; a force information acquisition unit configured to obtain first force information indicating force generated when the first operation is performed; a first operation completion determination unit configured to determine completion of the first operation; a second operation controller configured to, after the completion of the first operation, cause the robot to perform a second operation based on the first force information for a verification task that verifies completion of the task with the contact; and a second operation completion determination unit configure to determine completion of the second operation.

For example, in order to determine whether or not the task with the contact, such as inserting a connector, fastening a screw, or turning a key, has been successful, a person may perform a verification task, such as lightly pulling the inserted connector, gently turning the screw in the reverse direction, or slightly turning the key backward. Since the person remembers a feeling of force applied when performing the task with the contact, the person can perform such a verification task. Accordingly, according to the present disclosure, the second operation for the verification task is performed based on the force generated when the robot performs the first operation for the task with the contact. In other words, the second operation is performed while the force generated in the first operation is took into account; therefore, the verification task similar to what the person would do, such as lightly pulling the inserted connector, gently turning the screw in the reverse direction, or slightly turning the key backward, can be performed. Consequently, it is determined whether the task with the contact performed by the robot has succeeded or not.

Technology 2: The robot control system according to technology 1, in which the second operation controller is configured to cause the robot to perform the second operation with a force weaker than the force indicated by the first force information.

According to this technology, since the second operation is performed with the force weaker than the force generated during the first operation, the task with the contact between the first and second objects is prevented from ending in failure due to the verification task despite having succeeded.

Technology 3: The robot control system according to technology 2, in which the second operation controller is configured to cause the robot to perform the second operation at least twice consecutively.

According to this technology, the second operation is performed at least twice, allowing the verification task to be performed more reliably.

Technology 4: The robot control system according to technology 3, in which the second operation controller is configured to cause the robot to subsequently perform the second operation with a force weaker than a force with which the second operation is precedingly performed.

According to this technology, since the force with which the second operation is performed is gradually reduced, the task with the contact between the first and second objects can be further prevented from resulting in failure due to the verification task despite having succeeded.

Technology 5: The robot control system according to any one of technologies 2 to 4, in which a direction of force acts on the first object and the second object in the second operation is opposite to a direction of force that acts on the first object and the second object in to the first operation.

According to this technology, the second operation is performed with the force in the direction opposite to that of the force of the first operation, thereby enabling the verification task.

Technology 6: The robot control system according to any one of technologies 1 to 5, further including an image acquisition unit configured to obtain image information indicating an image including the first object and the second object. The first operation controller is configured to cause the robot to perform the first operation based on the image information.

According to this technology, the use of the image information enables the first operation to be accurate.

Technology 7: The robot control system according to technology 6, in which the first operation completion determination unit is configured to determine the completion of the first operation based on the image information. The second operation completion determination unit is configured to determine the completion of the second operation based on the image information.

According to this technology, the use of the image information enables, on an image, the determination of the completion of the first operation (i.e., the task with the contact between the first and second objects) based on the image and the determination of the completion of the second operation (i.e., the verification task).

Technology 8: The robot control system according to any one of technologies 1 to 7, in which the force information acquisition unit is configured to obtain second force information indicating force generated when the second operation is performed.

According to this technology, the second force information can be used for determining the completion of the second operation or for display.

Technology 9: The robot control system according to technology 8, in which the first operation completion determination unit is configured to determine the completion of the first operation based on the first force information. The second operation completion determination unit is configured to determine the completion of the second operation based on the second force information.

According to this technology, the use of the force information items allows changes in the forces during the first and second operations to be identified. Therefore, the completion of the first operation (i.e., the task with the contact between the first and second objects) and the completion of the second operation (i.e., the verification task) can be determined.

Technology 10: The robot control system according to technology 8 or 9, further including a display controller configured to display the first force information and the second force information.

According to this technology, a user can check the first force information and the second force information.

Technology 11: The robot control system according to technology 10, in which the display controller is configured to display the first force information and the second force information side by side.

According to this technology, the user can check the first force information and the second force information while comparing the first force information and the second force information.

Technology 12: The robot control system according to technology 10, in which the display controller is configured to display the first force information and the second force information while allowing the first force information and the second force information to overlap each other.

According to this technology, the user can check the first force information and the second force information while comparing the first force information and the second force information.

Technology 13: The robot control system according to technology 11 or 12, in which the display controller is configured to display the first force information and the second force information while reversing a sign of one of the first force information and the second force information.

When the direction of the force from the second operation is opposite to the direction of the force from the first operation, displaying the first force information and the second force information as they are may cause the user to hardly compare the first force information and the second force information. In contrast, inverting the sign of one of the first force information and the second force information allows the user to easily compare the first force information and the second force information.

Technology 14: A method of controlling a robot, the method being executable by a robot control system that controls the robot. The method includes: causing the robot to perform a first operation for a task with a contact between a first object and a second object; obtaining first force information indicating force generated when the first operation is performed; determining completion of the first operation; after the completion of the first operation, causing the robot to perform a second operation based on the first force information for a verification task that verifies completion of the task with the contact; and determining completion of the second operation.

According to this technology, the provided robot control method enables determination of whether or not the task with the contact performed by the robot has succeeded.

Technology 15: A program to cause a computer to execute the method according to technology 14.

According to this technology, the provided program enables determination of whether or not the task with the contact performed by the robot has succeeded.

### INDUSTRIAL APPLICABILITY

The present disclosure is applicable to robot control systems that control robots.

### REFERENCE MARKS IN DRAWINGS

100 robot control system
101 image acquisition unit
102 force information acquisition unit
103 first operation controller
104 storage unit
105 first operation completion determination unit
106 second operation controller
107 second operation completion determination unit
108 display controller
109 robot
110 camera
111 sensor
112 monitor
201, 202 object

1. A robot control system configured to control a robot, the robot control system comprising:
a first operation controller configured to cause the robot to perform a first operation for a task with a contact between a first object and a second object;
a force information acquisition unit configured to obtain first force information indicating force generated when the first operation is performed;
a first operation completion determination unit configured to determine completion of the first operation;
a second operation controller configured to, after the completion of the first operation, cause the robot to perform a second operation based on the first force information for a verification task that verifies completion of the task with the contact; and
a second operation completion determination unit configure to determine completion of the second operation.

2. The robot control system according to claim 1, wherein the second operation controller is configured to cause the robot to perform the second operation with a force weaker than the force indicated by the first force information.

3. The robot control system according to claim 2, wherein the second operation controller is configured to cause the robot to perform the second operation at least twice consecutively.

4. The robot control system according to claim 3, wherein the second operation controller is configured to cause the robot to subsequently perform the second operation with a force weaker than a force with which the second operation is precedingly performed.

5. The robot control system according to claim 2, wherein a direction of force acts on the first object and the second object in the second operation is opposite to a direction of force that acts on the first object and the second object in to the first operation.

6. The robot control system according to claim 1, further comprising an image acquisition unit configured to obtain image information indicating an image including the first object and the second object, wherein
the first operation controller is configured to cause the robot to perform the first operation based on the image information.

7. The robot control system according to claim 6, wherein
the first operation completion determination unit is configured to determine the completion of the first operation based on the image information, and
the second operation completion determination unit is configured to determine the completion of the second operation based on the image information.

8. The robot control system according to claim 1, wherein the force information acquisition unit is configured to obtain second force information indicating force generated when the second operation is performed.

9. The robot control system according to claim 8, wherein
the first operation completion determination unit is configured to determine the completion of the first operation based on the first force information, and
the second operation completion determination unit is configured to determine the completion of the second operation based on the second force information.

10. The robot control system according to claim 8, further comprising a display controller configured to display the first force information and the second force information.

11. The robot control system according to claim 10, wherein the display controller is configured to display the first force information and the second force information side by side.

12. The robot control system according to claim 10, wherein the display controller is configured to display the first force information and the second force information while allowing the first force information and the second force information to overlap each other.

13. The robot control system according to claim 11, wherein the display controller is configured to display the first force information and the second force information while reversing a sign of one of the first force information and the second force information.

14. A method of controlling a robot, the method being executable by a robot control system that controls the robot, the method comprising:
causing the robot to perform a first operation for a task with a contact between a first object and a second object;
obtaining first force information indicating force generated when the first operation is performed;
determining completion of the first operation;
after the completion of the first operation, causing the robot to perform a second operation based on the first force information for a verification task that verifies completion of the task with the contact; and
determining completion of the second operation.

15. A program to cause a computer to execute the method according to claim 14.
